(19) United States
(12) Patent Application Publication
(10) Pub. No.: US 2015/0103105 A1
(43) Pub. Date: Apr. 16, 2015

(54) DISPLAY APPARATUS, METHOD OF DRIVING THE SAME, AND PORTABLE TERMINAL INCLUDING THE SAME

(71) Applicant: Samsung Electronics Co., Ltd., Suwon-si (KR)

(72) Inventors: Su-yeon KIM, Suwon-si (KR); Dong-sub KIM, Suwon-si (KR); Hyun-chang SHIN, Seongnam-si (KR)

(21) Appl. No.: 14/513,658

(22) Filed: Oct. 14, 2014

(30) Foreign Application Priority Data
Oct. 14, 2013 (KR) 10-2013-0122212

(51) Int. Cl. G09G 3/36; G09G 5/10

(52) U.S. Cl. CPC G09G 3/36; G09G 5/10
USPC 345/690; 345/102

(57) ABSTRACT

A display apparatus, a method for driving the display apparatus, and a portable terminal are provided. The display apparatus includes a display panel including a plurality of pixels, a plurality of gate lines connected to the plurality of pixels, and a plurality of data lines connected to the plurality of pixels, a backlight unit configured to emit light on the display panel, an image signal convertor configured to convert received image data to be suitable for a pixel arrangement of the display panel, a backlight driver configured to adjust a brightness of the backlight unit based on the converted image data, and a host controller configured to adjust a brightness change speed, when the brightness of the backlight unit is changed in correspondence with a change in the image data.

### CROSS-REFERENCE TO RELATED APPLICATION(S)

This application claims the benefit under 35 U.S.C. §119(a) of a Korean patent application filed on Oct. 14, 2013 in the Korean Intellectual Property Office and assigned Serial number 10-2013-0122212, the entire disclosure of which is hereby incorporated by reference.

### TECHNICAL FIELD

The present disclosure relates to a display apparatus, a method of driving the display apparatus, and a portable terminal. More particularly, the present disclosure relates to a display apparatus for performing a dynamic backlight control, a method of driving the display apparatus, and a portable terminal for performing the same.

### BACKGROUND

When a resolution of a liquid crystal display (LCD) apparatus is high, an aperture ratio of an LCD panel is reduced, thereby decreasing a brightness of the LCD panel. To prevent this decrease in the brightness, a PenTile pixel structure has been used. In the PenTile pixel structure, when two dots are displayed, a blue unit pixel may be shared by the two dots. However, this PenTile pixel structure introduces flickering. In addition, to improve the brightness in comparison to the PenTile pixel structure, a PenTile RGBW pixel structure in which a white pixel is added to red, green, and blue pixels may be used. When a backlight included in the LCD apparatus is controlled, a dynamic backlight control function is used to reduce power consumption and improve image quality.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a display apparatus for improving flickering on a display panel of a PenTile pixel structure, a method for driving the display apparatus, and a portable terminal for performing the same.

Additional aspects will be set forth in part in the description which follows and, in part, will be apparent from the description, or may be learned by practice of the presented embodiments.

In accordance with an aspect of the present disclosure, a display apparatus is provided. The apparatus includes a display panel including a plurality of pixels, a plurality of gate lines connected to the plurality of pixels, and a plurality of data lines connected to the plurality of pixels, a backlight unit configured to emit light on the display panel, a data driver configured to apply a data signal to the plurality of data lines, an image signal convertor configured to convert received image data to be suitable for a pixel arrangement of the display panel and to provide the converted image data to the data driver, a backlight driver configured to adjust a brightness of the backlight unit based on the converted image data, and a host controller configured to adjust a brightness change speed, when the brightness of the backlight unit is changed in correspondence with a change in the received image data.

In accordance with another aspect of the present disclosure, the host controller may be further configured to set a brightness change delay time from a time point at which a change in brightness of the backlight unit is started to a time point at which the brightness of the backlight unit reaches a target brightness.

In accordance with another aspect of the present disclosure, the backlight driver may be further configured to adjust a slew rate of a current output to be provided to the backlight unit, based on the brightness change delay time.

In accordance with another aspect of the present disclosure, the backlight driver may be further configured to adjust a rate of change in a duty ratio of a pulse width modulation signal to be provided to the backlight unit, based on the brightness change delay time.

In accordance with another aspect of the present disclosure, the host controller may be further configured to determine a brightness setting which is input through a user interface and to set the brightness change delay time depending on the brightness setting.

In accordance with another aspect of the present disclosure, the host controller may be further configured to increase the brightness change delay time as the brightness setting is increased.

In accordance with another aspect of the present disclosure, the backlight driver may be further configured to analyze a histogram of the converted image data and to set the brightness of the backlight unit based on a result of the analysis.

In accordance with another aspect of the present disclosure, the image signal convertor may be further configured to scale the converted image data in correspondence with the set brightness of the backlight unit.

In accordance with another aspect of the present disclosure, the display panel may further include red, green, blue, and white sub-pixels.

In accordance with another aspect of the present disclosure, the image signal convertor may be further configured to receive RGB data including data of red, green, and blue colors as the received image data and to convert the received RGB data into RGBW data including data of red, green, blue, and white colors.

In accordance with another aspect of the present disclosure, a portable terminal is provided. The portable terminal includes a display panel including a plurality of unit pixels, each unit pixel of the plurality of unit pixels including red (R), green (G), blue (B), and white (W) sub-pixels, a backlight unit configured to emit light on the display panel, an application processor configured to determine a brightness setting based on a signal input through a user interface and to output a brightness setting signal, a timing controller configured to convert received RGB image data including data of red, green and blue colors into RGBW image data including data of red, green, blue and white colors and to set a brightness change delay time of a backlight unit based on the brightness setting signal, and a backlight driver configured to drive the backlight unit and to adjust a brightness of the backlight unit based on the brightness change delay time and the RGBW image data.

In accordance with another aspect of the present disclosure, the timing controller may include an image convertor configured to convert the received RGB image data into the RGBW image data, and a delay decision unit configured to set the brightness change delay time in response to the brightness setting signal.

In accordance with another aspect of the present disclosure, the delay decision unit may be further configured to set the brightness change delay time based on the brightness setting signal and the brightness of the backlight unit.

In accordance with another aspect of the present disclosure, the backlight driver may be further configured to adjust a slew rate of a current to be provided to the backlight unit, based on the brightness change delay time.

In accordance with another aspect of the present disclosure, the backlight driver may be further configured to adjust a rate of change in a duty ratio of a pulse width modulation signal to be provided to the backlight unit, based on the brightness change delay time.

In accordance with another aspect of the present disclosure, a method of driving a display apparatus is provided. The method includes setting, by a host controller of the display apparatus, a brightness change delay time according to a brightness setting set by a user, converting image data to be suitable for a pixel arrangement of a display panel, determining a brightness of a backlight unit based on a result of an analysis of the converted image data, and changing the brightness of the backlight unit to the set brightness of the backlight unit according to the brightness change delay time.

In accordance with another aspect of the present disclosure, the changing of the brightness of the backlight unit may include adjusting a slew rate of power to be provided to the backlight unit, based on the brightness change delay time.

In accordance with another aspect of the present disclosure, the changing of the brightness of the backlight unit may include adjusting a rate of change in a duty ratio of a pulse width modulation signal to be provided to the backlight unit, based on the brightness change delay time.

In accordance with another aspect of the present disclosure, the display panel may include red, green, blue, and white sub-pixels.

In accordance with another aspect of the present disclosure, the brightness change delay time may be increased as the brightness setting is increased.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a display apparatus according to an embodiment of the present disclosure;

FIGS. 2A and 2B illustrate pixel arrangement patterns according to various embodiments of the present disclosure;

FIG. 3 illustrates a brightness for each image in a pixel arrangement of a PenTile structure according to an embodiment of the present disclosure;

FIG. 4A is a graph showing a change in a brightness of a display apparatus according to the related art;

FIG. 4B is a graph showing a change in a brightness of a display apparatus according to an embodiment of the present disclosure;

FIG. 5 is a block diagram of an image signal convertor and a backlight driver according to an embodiment of the present disclosure;

FIG. 6 is a timing diagram illustrating a change in a duty ratio of a pulse width modulation (PWM) signal according to an embodiment of the present disclosure;

FIG. 7 is a graph illustrating a slew rate of a current according to an embodiment of the present disclosure;

FIG. 8 is a block diagram of a display apparatus according to an embodiment of the present disclosure;

FIG. 9 is a block diagram of a timing controller and a backlight driver according to an embodiment of the present disclosure;

FIG. 10 is a flowchart of a method of driving a display apparatus according to an embodiment of the present disclosure;

FIG. 11 is a block diagram of a display system according to an embodiment of the present disclosure; and

FIG. 12 is a block diagram of an electronic system including a display device, and interfaces of the electronic system according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, expressions such as “at least one of,” when preceding a list of elements, modify the entire list of elements and do not modify the individual elements of the list.

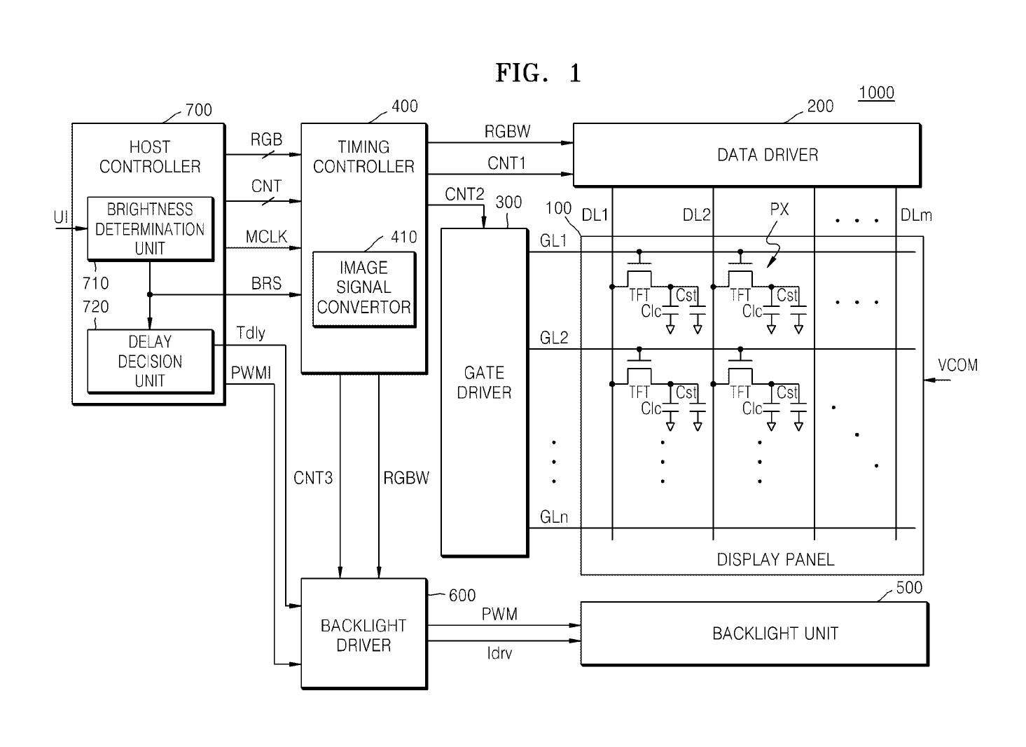

FIGS. 1 through 12, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

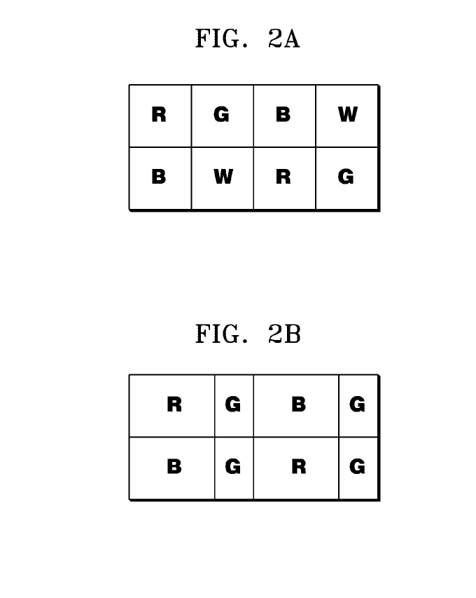

FIG. 1 is a block diagram of a display apparatus according to an embodiment of the present disclosure, and FIGS. 2A and 2B illustrate pixel arrangement patterns according to an embodiment of the present disclosure.

Referring to FIG. 1, a display apparatus 1000 is illustrated, where the display apparatus 1000 may be a portable terminal or a portable electronic device for communication, which performs an image display function. For example, the display apparatus 1000 may be at least one of a laptop computer, a mobile phone, a smartphone, a tablet personal computer (PC), a personal digital assistant (PDA), an enterprise digital assistant (EDA), a digital still camera, a digital video camera, a portable multimedia player (PMP), a personal or portable navigation device (PND), a handheld game console, a mobile internes device (MID), an e-book and the like.

The display apparatus 1000 may include a display panel 100 for displaying an image, a backlight unit 500 for emitting light on the display panel 100, display driving circuits 200, 300, 400, and 600 for driving the display panel 100 and the backlight unit 500 based on image data RGB and control signals CNT, MCLK, and BRS, and a host controller 700 for providing control signals CNT, MCLK, BRS, Tdly, and PWMI and the image data RGB to the display driving circuits 200, 300, 400, and 600. The display driving circuits 200, 300, 400, and 600 may include a data driver 200, a gate driver 300, a timing controller 400, and a backlight driver 600.

The display panel 100 includes a plurality of gate lines GL1 to GLn through which a scan signal is transferred in a row direction, a plurality of data lines DL1 to DLm which are arranged in a column direction crossing the plurality of gate lines GL1 to GLn and through which a gradation voltage corresponding to pixel data is transferred, and a plurality of pixels PX arranged in regions where the plurality of gate lines GL1 to GLn and the plurality of data lines DL1 to DLm cross each other.

Referring to FIGS. 2A and 2B, pixel arrangement patterns, which may be applied to a display panel 100, as, for example, illustrated in FIG. 1, are illustrated. The display panel 100 applied to one or more embodiments of the present disclosure is a panel in which pixels are arranged in a PenTile scheme. For example, the display panel 100 may be a panel of a PenTile structure including red (R), green (G), blue (B), and white (W) pixels or including red (R), green (G) and blue (B) pixels. However, the display panel 100 is not limited thereto. The display panel 100 may be a panel including a type of a pixel besides R, G, and B pixels.

Referring to FIGS. 2A, R, G, B, and W pixels are illustrated, where R, G, B and W pixels are sequentially arranged in an odd row, and B, W, R, and G pixels are sequentially arranged in an even row. Accordingly, R and B pixels are cross-arranged in an odd column, and G and W pixels are cross-arranged in an even column. Besides the arrangement method described above, various arrangement methods may be possible, wherein R, G, B, and W pixels are arranged such that same colored pixels are not continuously arranged in row and column directions.

Referring to FIGS. 2B, R, G, B and G pixels are illustrated, where R, G, B and G pixels are sequentially arranged in an odd row and B, G, R and G pixels are sequentially arranged in an even row. A number of the G pixels may be greater than a number of each of the R and B pixels. In an embodiment of the present disclosure, a size of the R and B pixels may be larger than a size of the G pixels. For example, the size of the R and B pixels may be twice the size of the G pixels.

When the display panel 100 is an LCD panel including a thin film transistor (TFT), each pixel PX includes a TFT of which a gate electrode and a source electrode are connected to a gate line GL and a data line DL, respectively, and a liquid crystal capacitor Clc and a storage capacitor Cst are connected to a drain electrode of the thin film transistor TFT. One end of each of the liquid crystal capacitor Clc and the storage capacitor Cst may be connected to a common voltage VCOM. In the pixel structure described above, when a gate line GL is selected, a thin film transistor TFT of a pixel PX connected to the selected gate line GL is turned on, and thereafter, a data signal including pixel information, e.g., a gradation voltage, is applied to each data line DL. The gradation voltage is applied to a liquid crystal capacitor Clc and a storage capacitor Cst of the corresponding pixel PX via the thin film transistor TFT of the corresponding pixel PX to drive the liquid crystal capacitor Clc and the storage capacitor Cst, thereby achieving a display operation.

Although FIG. 1 illustrates that the display panel 100 is an LCD panel, one or more embodiments of the present disclosure are not limited thereto. The display panel 100 may be implemented by a different type of flat display panel operating based on light emitted by a separate light source, i.e., the backlight unit 500. For convenience of description, the present disclosure will be hereinafter described using an LCD apparatus as an example.

The data driver 200 receives converted image data RGBW and a first control signal CNT1 from the timing controller 400 and drives the plurality of data lines DL1 to DLm of the display panel 100 based on the converted image data RGBW and the first control signal CNT1. The data driver 200 generates a plurality of gradation voltages and outputs a gradation voltage corresponding to each pixel PX to each of the plurality of data lines DL1 to DLm of the display panel 100. The data driver 200 may be implemented by a single chip or a plurality of chips.

The gate driver 300 sequentially scans the plurality of gate lines GL1 to GLn of the display panel 100. The gate driver 300 activates a selected gate line by applying a gate-on voltage to the selected gate line, and the data driver 200 outputs corresponding gradation voltages to pixels PX connected to the activated gate line. Accordingly, the display panel 100 may sequentially display an image in horizontal line units, i.e., row by row. According to an embodiment of the present disclosure, when the display panel 100 is formed of a low temperature polysilicon (LTPS) material, the gate driver 300 may be directly mounted on the display panel 100.

The timing controller 400 may receive image data RGB, a control signal CNT, a clock signal MCLK, a brightness setting signal BRS, and the like from the outside, e.g., the host controller 700, and generate signals necessary to operate the data driver 200, the gate driver 300, and the backlight driver 600, e.g., first to third control signals CNT1, CNT2, and CNT3. The first to third control signals CNT1, CNT2, and CNT3 may include a plurality of timing signals, such as a vertical synchronization signal, a horizontal synchronization signal, a latch signal, a clock signal, an output enable signal, and the like.

The timing controller 400 may include an image signal convertor 410. The image signal convertor 410 may be implemented by a separate device other than the timing controller 400 and may exist outside the timing controller 400. The image signal convertor 410 may generate converted image data RGBW by converting the image data RGB input to the timing controller 400 to be suitable for the pixel arrangement of the display panel 100. For example, the image signal convertor 410 may convert the image data RGB including data corresponding to red, blue, and green colors into the converted image data RGBW including data corresponding to red, blue, green, and white colors. The converted image data RGBW may be provided to the backlight driver 600 and the data driver 200.

Although not shown, the timing controller 400 may further include a frame memory, wherein the image data RGB received from the outside may be temporarily stored in the frame memory, and the frame memory may be used for image conversion and the like. In addition, the timing controller 400 may further include a register for storing control signals received from the host controller 700.

The backlight unit 500 provides light to the display panel 100. The backlight unit 500 may be provided on a surface corresponding to a lower substrate of the display panel 100, e.g., a liquid crystal panel, or provided on one side surface of the display panel 100 together with a reflective plate. The backlight unit 500 according to an embodiment of the present disclosure may include a plurality of light-emitting diodes (LEDs) as a light source. The backlight unit 500 may operate by receiving a pulse width modulation signal PWM and a driving current Idrv (or a driving voltage Vdrv) from, for example, the backlight driver 600.

The backlight driver 600 is a circuit for controlling an operation of the backlight unit 500 and may adjust a brightness of the backlight unit 500 based on the converted image data RGBW. The backlight driver 600 may generate the pulse width modulation signal PWM for driving the backlight unit 500, based on a pulse width modulation interface signal PWMI provided from the host controller 700. The backlight driver 600 may analyze a histogram of the converted image data RGBW provided from the timing controller 400 and set the brightness of the backlight unit 500 based on a result of the analysis. When an image is changed, i.e., the image data RGB corresponding to the image displayed on the display panel 100 is changed, the histogram depending on frame data of the converted image data RGBW may be changed, thereby changing the brightness of the backlight unit 500. In this case, the backlight driver 600 may adjust a brightness change speed of the backlight unit 500 based on a brightness change delay signal Tdly received from the host controller 700. According to an embodiment of the present disclosure, the backlight driver 600 may be included in the timing controller 400.

The timing controller 400 and the backlight driver 600 may include a serial interface (not shown) for communication with the host controller 700. For example, the serial interface may be any one of a mobile industry processor interface (MIPI®), a mobile display digital interface (MDDI), a DisplayPort interface, an inter-integrated circuit (I2C) interface, and an Embedded DisplayPort (eDP) interface.

The host controller 700 controls a general operation related to the display driving. For example, when the display apparatus 1000 is a portable terminal, such as a smartphone or a tablet PC, the host controller 700 may be an application processor.

The host controller 700 may communicate with the timing controller 400 and the backlight driver 600 and provide various timing signals, e.g., the horizontal synchronization signal, the vertical synchronization signal, the clock signal MCLK, the brightness setting signal BRS, the brightness change delay time Tdly, the control signal CNT, and the image data RGB. The host controller 700 according to an embodiment of the present disclosure may adjust a bright change speed in correspondence with a change in the image data RGB when the brightness of the backlight unit 500 is changed as described above. To this end, the host controller 700 may include a brightness determination unit 710 and a delay decision unit 720. The brightness determination unit 710 determines a brightness setting of the display apparatus 1000, i.e., brightness set by a user as basic brightness of the display apparatus 1000, based on a signal input through a user interface UI. The brightness determination unit 710 may output the determined brightness setting as the brightness setting signal BRS. The delay decision unit 720 may set the brightness change delay time Tdly depending on the brightness setting signal BRS. The brightness change delay time Tdly indicates a time from a time point at which a change in brightness of the backlight unit 500 is started to a time point at which the brightness of the backlight unit 500 reaches a target brightness. For example, as the brightness setting is increased, the brightness change delay time Tdly may be increased. However, the brightness change delay time Tdly is not limited thereto. The brightness change delay time Tdly for each value of the brightness setting may be set variously according to characteristics of the display panel 100 and the like. For example, the brightness change delay time Tdly may be experimentally set within a range where a brightness change is not recognized for each value of the brightness setting, and brightness change delay time Tdly for each value of the brightness setting may be stored in a lookup table by the delay decision unit 720. When the brightness setting signal BRS corresponding to the brightness setting set based on the signal received through the user interface UI is received by the delay decision unit 720, a value corresponding to the brightness setting signal BRS may be output from among the pre-stored values of the brightness change delay time Tdly.

As described above, the display apparatus 1000 according to an embodiment of the present disclosure includes the display panel 100 having the pixel arrangement of the PenTile scheme and sets the brightness of the backlight unit 500 based on the converted image data RGBW into which the image data RGB has been converted to be suitable for the pixel arrangement of the display panel 100. In this case, when the brightness of the backlight unit 500 is changed, by adjusting a brightness change speed, and more particularly, by differently adjusting a brightness change speed for each value of the brightness setting, a flickering phenomenon caused by visualizing a change in the brightness of the display panel 100 when an image is changed may be reduced. This reduction of the flickering phenomenon will now be described in more detail.

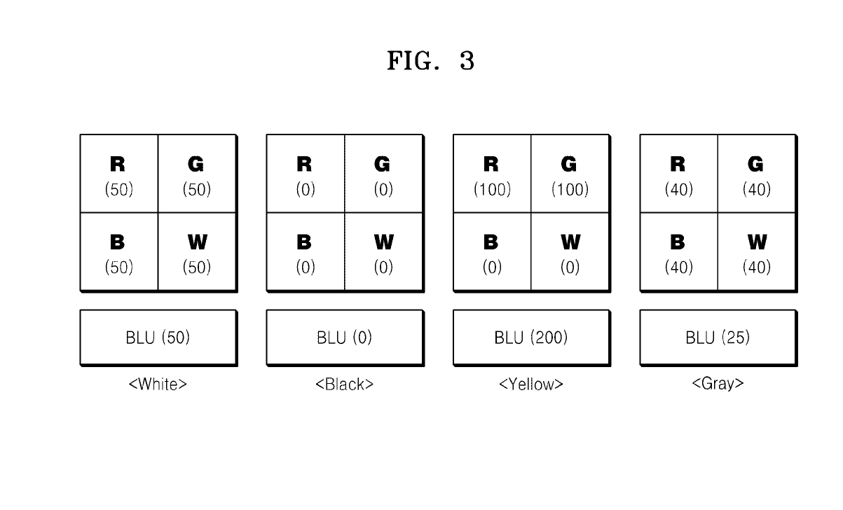

FIG. 3 illustrates a brightness for each image in a pixel arrangement of a PenTile structure according to an embodiment of the present disclosure.

Referring to FIG. 3, for a white image, a brightness of a backlight unit BLU may be set to 50 nit, and a brightness of each of R, G, B, and W pixels may be set to 50 nit. For a black image, a brightness of each of the backlight unit BLU and the R, G, B, and W pixels may be set to 0 nit. For a yellow image, a brightness of the backlight unit BLU may be set to 200 nit, and brightnesses of the R, G, B, and W pixels may be set to 100 nit, 100 nit, 0 nit, and 0 nit, respectively. For a gray image, a brightness of the backlight unit BLU may be set to 25 nit, and a brightness of each of the R, G, B, and W pixels may be set to 40 nit. As described above, the brightness of the backlight unit BLU may vary for each image. The particular numeric values described above are merely suggested for convenience of description, and the brightnesses of the backlight unit BLU and the R, G, B, and W pixels are not limited thereto. Brightnesses of the backlight unit BLU and each pixel may be variously set according to the brightness setting, a gamma value, the characteristics of a display panel 100, as, for example, illustrated in FIG. 1, and the like.

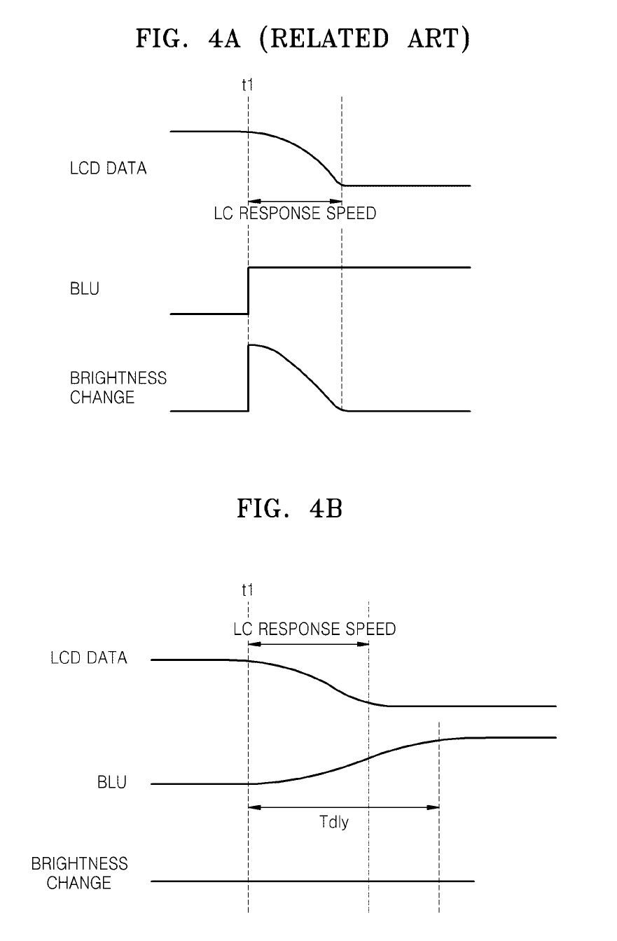

FIG. 4A is a graph showing a change in a brightness of a display apparatus according to the related art, and FIG. 4B is a graph showing a change in a brightness of a display apparatus according to an embodiment of the present disclosure.

Referring to FIGS. 4A and 4B, a brightness of a display apparatus 1000, as, for example, illustrated in FIG. 1, may be set based on total brightness according to image data LCD DATA displayed on a display panel 100, as, for example, illustrated in FIG. 1, e.g., a liquid crystal panel having a pixel arrangement of a PenTile structure, and a brightness of a backlight unit BLU. However, as shown in FIG. 4A, when an image is changed at a time point t1, and accordingly, when the brightness according to the image data LCD DATA on the liquid crystal panel, i.e., the converted image data RGBW, and the brightness of the backlight unit BLU are changed, the brightness of the backlight unit BLU is immediately changed, but a change in the brightness of the liquid crystal panel may be delayed due to a liquid crystal (LC) response speed. Accordingly, a rapid change in the brightness of the display apparatus 1000 is caused when an image is changed, thereby resulting in flickering on the display panel 100.

For example, a change in an image is assumed such that a full white image is displayed on the display panel 100 before the time point t1, and a white image is displayed on a portion of the display panel 100 and a black image is displayed on another portion of the display panel after the time point t1. Due to the change in an image at the time point t1, the brightness of the backlight unit BLU and the brightness according to the image data LCD DATA are changed after the time point t1. However, the brightness of the backlight unit BLU is immediately changed, while the image data LCD DATA is changed row by row in horizontal line units. In addition, due to the LC response speed, a brightness change speed of the backlight unit BLU differs from that according to the image data LCD DATA. For the portion on which the white image as displayed does not change before and after the time point t1, since the brightness change speed of the backlight unit BLU differs from that according to the image data LCD DATA, the brightness of the portion of the display panel 100 on which the white image is displayed changes rapidly after the time point t1.

However, the display apparatus 1000 according to an embodiment of the present disclosure may prevent a rapid brightness change on the display panel 100 by delaying a change in the brightness of the backlight unit BLU.

Referring to FIG. 4B, a display apparatus 1000, as, for example, illustrated in FIG. 1, according to an embodiment of the present disclosure adjusts a brightness change speed of a backlight unit BLU by setting a brightness change delay signal Tdly from a time point at which a change in brightness of the backlight unit BLU is started to a time point at which the brightness of the backlight unit BLU reaches a target brightness. Accordingly, the change in the brightness of the backlight unit BLU is delayed, and thus a rapid brightness change of the display apparatus 1000 does not occur regardless of a brightness change delay of image data LCD DATA displayed on the liquid crystal panel (e.g., regardless of the LC response speed). Therefore, flickering due to a change in an image may be prevented.

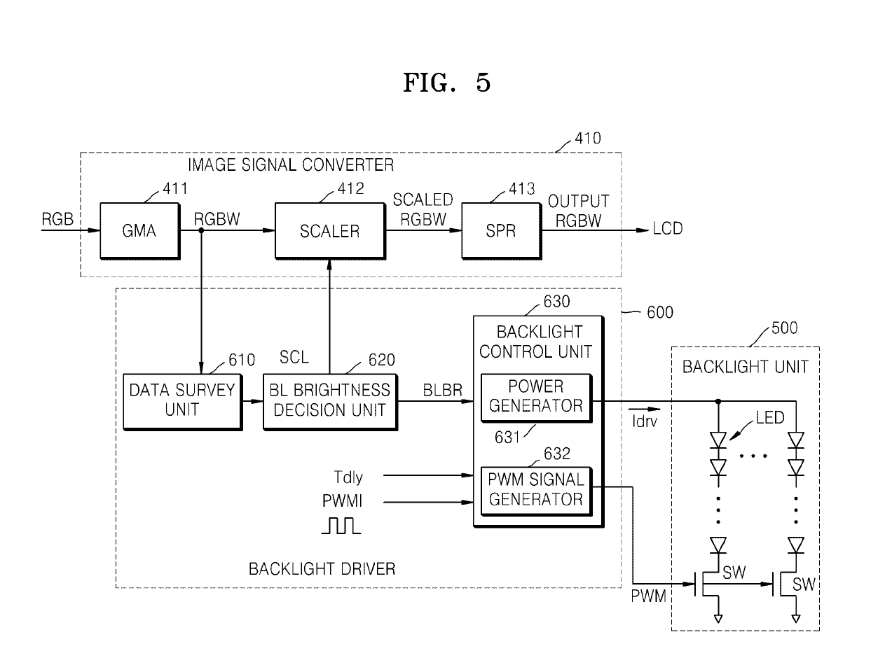

FIG. 5 is a block diagram of an image signal convertor and a backlight driver according to an embodiment of the present disclosure. For convenience of description, a backlight unit is also illustrated in FIG. 5.

Referring to FIG. 5, an image signal convertor 410 is illustrated, where the image signal convertor 410 includes a gamma mapping algorithm (GMA) 411, a scaler 412, a sub-pixel rendering unit (SPR) 413, and a backlight driver 600 is illustrated, where the backlight driver 600 includes a data survey unit 610, a backlight (BL) brightness decision unit 620, and a backlight control unit 630.

The image signal convertor 410 converts image data RGB consisting of data of red, green, and blue colors into image data RGBW further including a color besides the red, green, and blue colors. Since the converted image data RGBW further includes the additional color, e.g., a white (W) color, the image signal convertor 410 may increase a representable color brightness region compared with a typical LCD apparatus including R, G, and B pixels. Therefore, the backlight driver 600 analyzes a histogram of the converted image data RGBW and changes the brightness of the backlight unit 500 in consideration of a correlation between current brightness of the backlight unit 500 and a color brightness region. Accordingly, the backlight driver 600 and/or the BL brightness decision unit 620 outputs a readjustment backlight brightness adjustment signal BLBR and a scale value SCL for scaling the converted image data RGBW according to the readjustment backlight brightness adjustment signal BLBR.

The GMA 411 includes a gamma mapping algorithm formula and converts the image data RGB into the converted image data RGBW including an image signal for white pixels.

The data survey unit 610 receives the converted image data RGBW and analyzes a histogram of the converted image data RGBW. The backlight brightness decision unit 620 sets a brightness of the backlight unit 500 according to the backlight brightness adjustment signal BLBR and the scale value SCL according to the histogram analysis result.

The scale value SCL is provided to the scaler 412 of the image signal convertor 410. The scaler 412 scales a data value of the converted image data RGBW in correspondence with the brightness of the backlight unit 500.

The converted image data RGBW scaled by the scaler 412 is delivered to the SPR 413, and the SPR 413 allocates a properly converted data value to each of the R, G, B, and W pixels by matching data of pixels arranged in the existing typical RGB stripe pattern with data of pixels arranged in an RGBW PenTile pattern. Accordingly, the display panel 100, e.g., a liquid crystal panel LCD, is driven based on the output converted image data RGBW.

The backlight brightness adjustment signal BLBR output from the backlight brightness decision unit 620 is provided to the backlight control unit 630, and the backlight control unit 630 controls the backlight unit 500 based on the backlight brightness adjustment signal BLBR, a brightness change delay time Tdly, and a pulse width modulation interface signal PWMI.

The backlight control unit 630 includes a power generator 631 and a pulse width modulation (PWM) signal generator 632. The power generator 631 generates a driving current Idrv (or driving voltage Vdrv) to be provided to LED arrays of the backlight unit 500. In this case, an amount of the driving current Idrv may be set based on the backlight brightness adjustment signal BLBR. The PWM signal generator 632 generates a pulse width modulation signal PWM for controlling a switch SW included in each LED of the LED array to be turned on or off. The PWM signal generator 632 may generate the pulse width modulation signal PWM based on the backlight brightness adjustment signal BLBR and the pulse width modulation interface signal PWMI.

When the brightness of the backlight unit 500 is changed, the power generator 631 or the PWM signal generator 632 may adjust a slew rate of the driving current Idrv and a delay time of the pulse width modulation signal PWM based on the brightness change delay time Tdly.

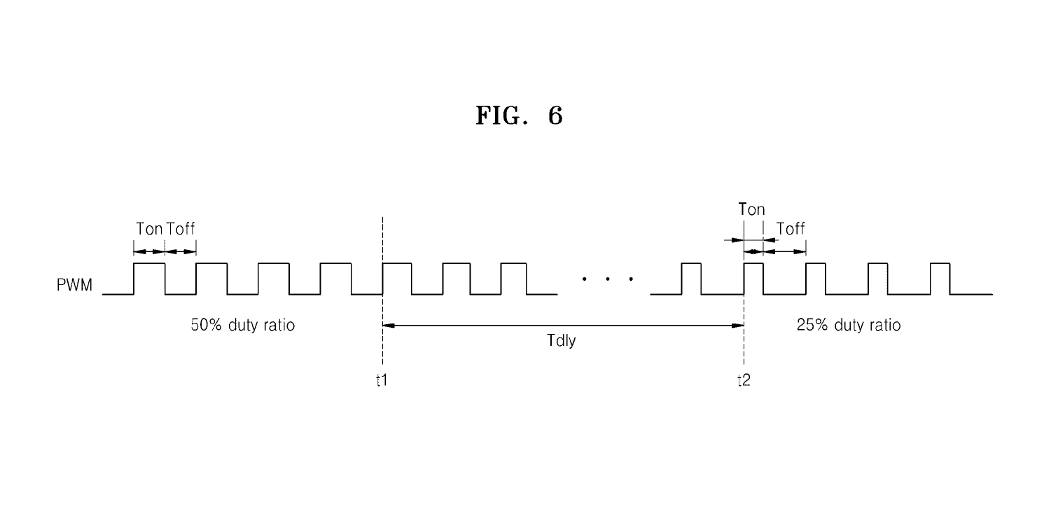

FIG. 6 is a timing diagram illustrating a change in a duty ratio of a PWM signal according to an embodiment of the present disclosure.

Referring to FIG. 6, when an image is changed at a time point t1, a brightness of a backlight unit 500, as, for example, illustrated in FIG. 5, is supposed to be changed accordingly. A PWM signal generator 632, as, for example, illustrated in FIG. 5, may change the brightness of the backlight unit 500 by adjusting a duty ratio of the pulse width modulation signal PWM (ratio of Ton to Toff). For example, when a current duty ratio is 50%, the duty ratio may be adjusted to 25% to decrease the brightness of the backlight unit 500 by 50% compared with the present brightness thereof. In this case, a time from a time point of starting to adjust the duty ratio, i.e., the time point t1, to a time point of changing the duty ratio to 50%, i.e., a time point t2, may be set according to a brightness change delay time Tdly.

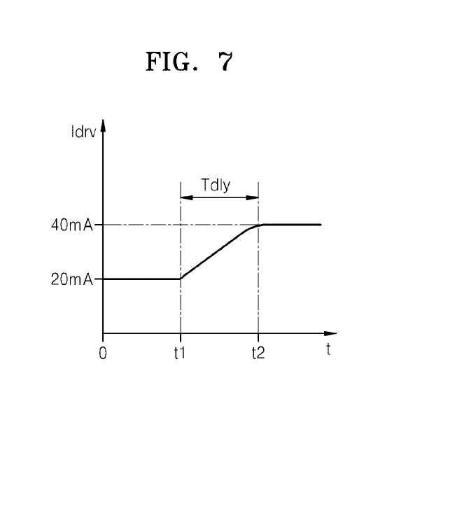

FIG. 7 is a graph illustrating a slew rate of a current according to an embodiment of the present disclosure.

Referring to FIG. 7, when a brightness of a backlight unit 500, as, for example, illustrated in FIG. 5, is supposed to be changed, a power generator 631, as, for example, illustrated in FIG. 5, may adjust a value of a driving current Idrv. As shown in FIG. 7, the brightness of the backlight unit 500 may be raised by increasing the driving current Idrv from 20 mA at time point t1 to 40 mA at time point t2. In this case, a speed in which the driving current Idrv increases, i.e., a slew rate, may be set according to a brightness change delay time Tdly.

As described above, when the brightness of the backlight unit 500 is changed, a change in brightness may be delayed based on the brightness change delay time Tdly received from a host controller 700, as, for example, illustrated in FIG. 1. In addition, the brightness change delay time Tdly may be set depending on a brightness setting signal BRS, as, for example, illustrated in FIG. 1.

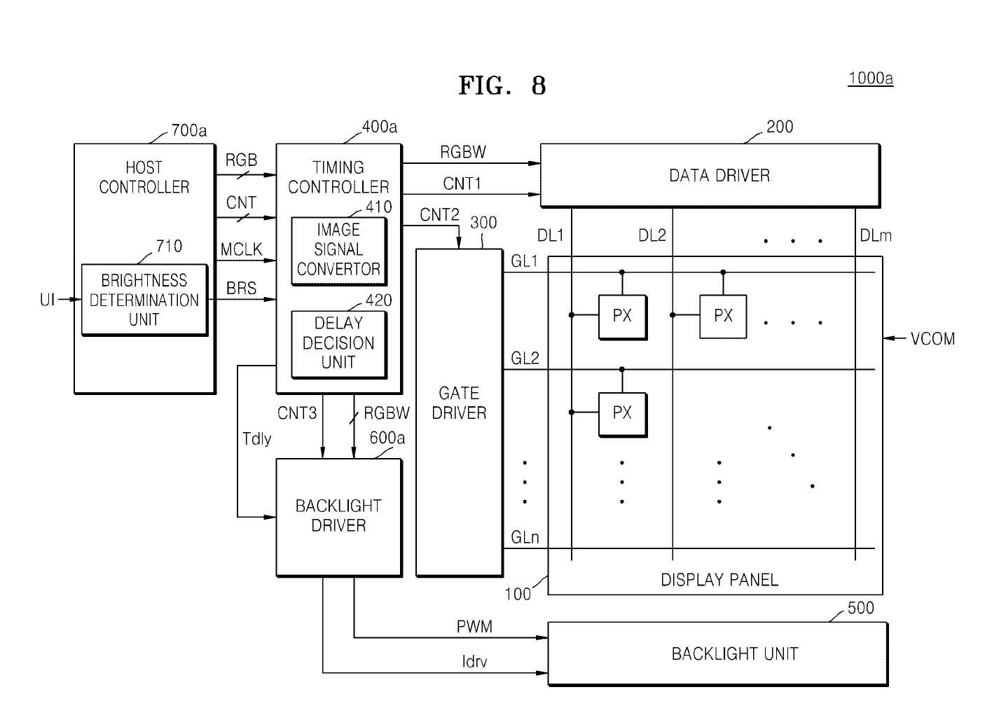

FIG. 8 is a block diagram of a display apparatus according to an embodiment of the present disclosure.

Referring to FIG. 8, a display apparatus 1000a is illustrated, where the display apparatus 1000a may include a display panel 100, a backlight unit 500, display driving circuits 200, 300, 400a, and 600a, and a host controller 700a. A configuration of the display apparatus 1000a of FIG. 8 is similar to that of a display apparatus 1000, as, for example, illustrated in FIG. 1. However, unlike the display apparatus 1000 of FIG. 1, a delay decision unit 420 may be located in a timing controller 400a in the display apparatus 1000a according to the current embodiment. The delay decision unit 420 may receive a brightness setting signal BRS from the host controller 700a, set a brightness change delay time Tdly based on a brightness setting indicated by the brightness setting signal BRS, and provide the set brightness change delay time Tdly to the backlight driver 600a. Other configurations and operations of the display apparatus 1000a of FIG. 8 are similar to those of the display apparatus 1000 of FIG. 1, and thus, descriptions thereof are not repeated.

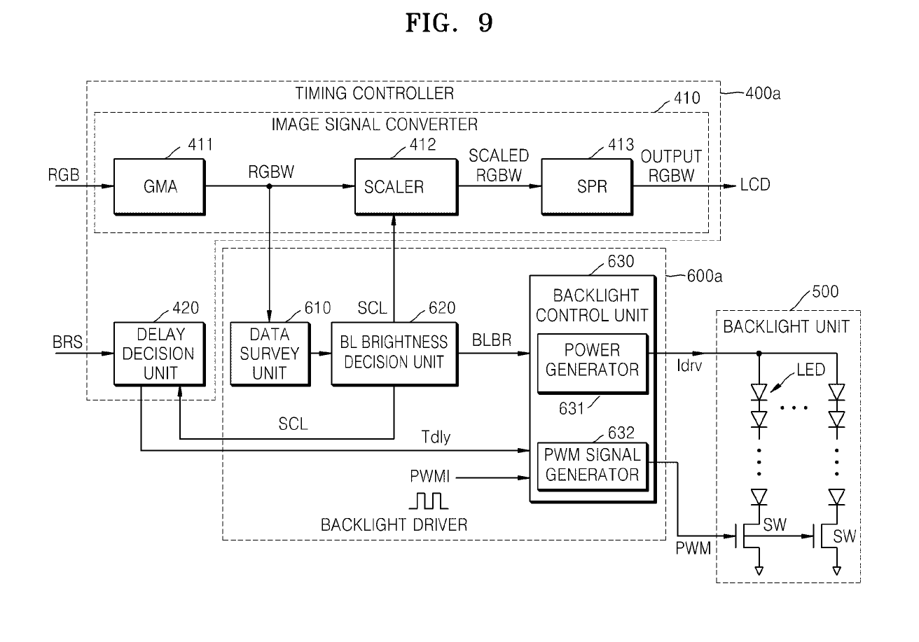

FIG. 9 is a block diagram of a timing controller and a backlight driver according to an embodiment of the present disclosure.

Referring to FIG. 9, a timing controller 400a is illustrated, where the timing controller 400a includes an image signal convertor 410 and a delay decision unit 420. The image signal convertor 410 includes a GMA 411, a scaler 412, and an SPR 413. Further, referring to FIG. 9, a backlight driver 600a is illustrated, where the backlight driver 600a includes a data survey unit 610, a backlight (BL) brightness decision unit 620, and a backlight control unit 630. Operations of components having same reference numerals as corresponding components in FIG. 5 are similar to those of the corresponding components in FIG. 5, and thus, descriptions thereof are not repeated.

The delay decision unit 420 sets and outputs the brightness change delay time Tdly based on a brightness setting signal BRS. The brightness change delay time Tdly may be provided to the backlight control unit 630 and set as a time period starting from a time point at which a change in brightness of the backlight unit 500 is started to a time point at which the brightness of the backlight unit 500 reaches a target brightness when the brightness of the backlight unit 500 is changed.

The backlight brightness adjustment signal BLBR output from the backlight brightness decision unit 620 may be provided not only to the scaler 412 but also to the delay decision unit 420. The delay decision unit 420 may set the brightness change delay time Tdly in consideration of the brightness setting signal BRS and the brightness of the backlight unit 500 which is changed depending on a change in an image. For example, when the brightness change delay time Tdly for the brightness setting signal BRS of 100 nit is set as one second, the delay decision unit 420 may increase or decrease the brightness change delay time Tdly in consideration of the backlight brightness adjustment signal BLBR. Since the brightness change delay time Tdly is set in consideration of not only the brightness setting signal BRS but also the changed brightness of the backlight unit 500, the brightness change delay time Tdly may be set to be suitable for the brightness setting and a change in brightness according to an image.

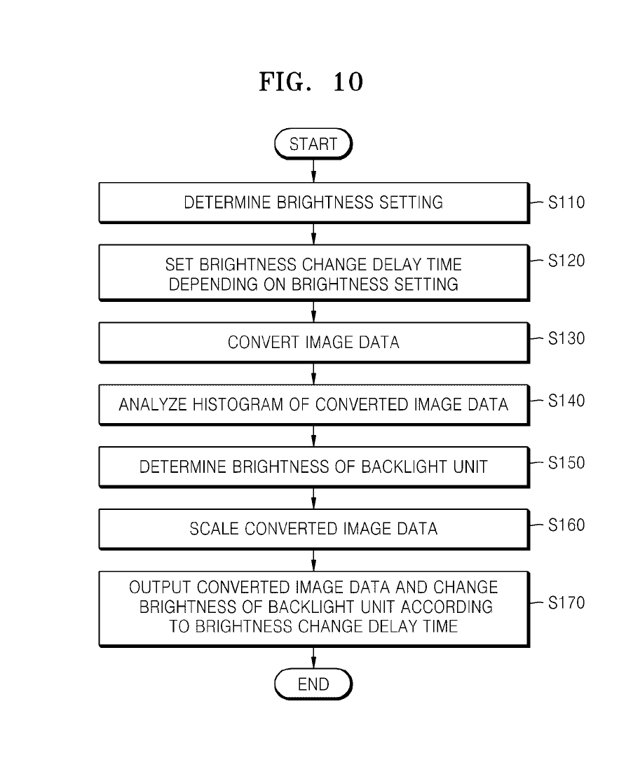

FIG. 10 is a flowchart of a method of driving a display apparatus according to an embodiment of the present disclosure.

Referring to FIG. 10, a brightness setting is determined in operation S110. A host controller 700, as, for example, illustrated in FIG. 1, may determine a brightness desired by a user, i.e., the brightness setting, based on a signal input through a user interface UI.

After, determining the brightness setting, a brightness change delay time depending on the brightness setting is set in operation S120. For example, the brightness change delay time may be variously set according to whether the brightness setting is a maximum value or a minimum value or a particular brightness value, i.e., according to brightness setting selected from among a maximum value, a minimum value, and a particular brightness value.

Thereafter, image data is converted to be suitable for a pixel structure of a display panel 100, as, for example, illustrated in FIG. 1, in operation S130, and a histogram of the converted image data is analyzed in operation S140. An image signal convertor of a timing controller 400, as, for example, illustrated in FIG. 1, may convert RGB image data into RGBW image data suitable for a pixel arrangement of a PenTile pattern. Brightness of a backlight unit 500, as, for example, illustrated in FIG. 1, is determined based on the histogram analysis result of the converted RGBW image data in operation S150. The brightness of the backlight unit 500 may be variously determined according to a type of an RGBW image.

Thereafter, the converted RGBW image data is scaled based on the set brightness of the backlight unit 500 in operation S160, and the converted RGBW image data is output to a data driver 200, as, for example, illustrated in FIG. 1, and the brightness of the backlight unit 500 is changed based on the set brightness change delay time in operation S170. For example, when the brightness change delay time is set as two seconds, and the brightness of the backlight unit 500 is changed from 50 nit to 200 nit, a time of two seconds may be taken to change the brightness of the backlight unit 500 from 50 nit to 200 nit.

The method described above relates to a display apparatus 1000 of FIG. 1, and when a delay decision unit 420, as, for example, illustrated in FIG. 1, sets the brightness change delay time based on a brightness setting signal and the brightness of the backlight unit 500 as described with reference to FIG. 9, the brightness change delay time setting operation S120 may be performed after the backlight unit brightness setting operation S150.

In this case, when the brightness of the backlight unit 500 is changed, by adjusting a brightness change speed, and more particularly, by differently adjusting a brightness change speed for each brightness setting, a flickering phenomenon caused by visualizing a change in brightness when an image is changed may be reduced.

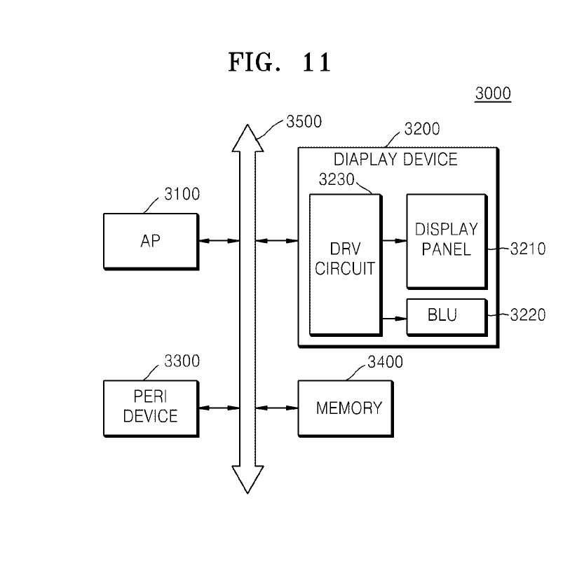

FIG. 11 is a block diagram of a display system according to an embodiment of the present disclosure.

Referring to FIG. 11, a display system 3000 is illustrated, where the display system 3000 may include an application processor (AP) 3100, a display device 3200, a peripheral device 3300, and a memory 3400, which are electrically connected to a system bus 3500.

The application processor 3100 may control the input and output of data to and from the peripheral (PHRI) device 3300, the memory 3400, and the display device 3200 and perform image processing of image data transmitted among the peripheral device 3300, the memory 3400, and the display device 3200.

The display device 3200 includes a display panel 3210, a backlight unit (BLU) 3220, and a driving (DRV) circuit 3230, stores image data received through the system bus 3500 in a frame memory included in the driving circuit 3230, and displays the image data on the display panel 3210. The display device 3200 may form a display apparatus 1000, as, for example, illustrated in FIG. 1, together with the application processor 3100. Therefore, a flickering phenomenon caused by visualizing a change in brightness may be prevented by setting a brightness change delay time of the backlight unit 3220.

The peripheral device 3300 may be a device for converting a video, a still image, or the like of a camera, a scanner, a webcam, or the like into an electrical signal. Image data acquired by the peripheral device 3300 may be stored in the memory 3400 or may be displayed on a panel of the display device 3200 in real-time.

The memory 3400 may include a volatile memory device, such as dynamic random access memory (DRAM), and/or a nonvolatile memory device, such as a flash memory. The memory 3400 may consist of DRAM, parameter random access memory (PRAM), magnetoresistive random access memory (MRAM), resistive random access memory (ReRAM), ferroelectric random access memory (FRAM), NOR flash memory, NAND flash memory, fusion flash memory (e.g., memory in which a static random access memory (SRAM) buffer, a NAND flash memory, and a NOR interface logic are combined), and the like. The memory 3400 may store image data acquired by the peripheral device 3300 or an image signal processed by the application processor 3100.

The display system 3000 according to an embodiment of the present disclosure may be included in a mobile electronic product such as a smartphone. However, the current embodiment is not limited thereto. The display system 3000 may be employed in various types of electronic products for displaying an image. That is, the display system 3000 may be not only employed in portable terminals, such as a tablet PC, an e-book, a PMP, a navigation device, and the like, but also widely used for TVs, automated teller machines (ATMs) for executing cash deposits and withdrawals for banks, elevators, ticket vending machines used for subways and the like, and the like.

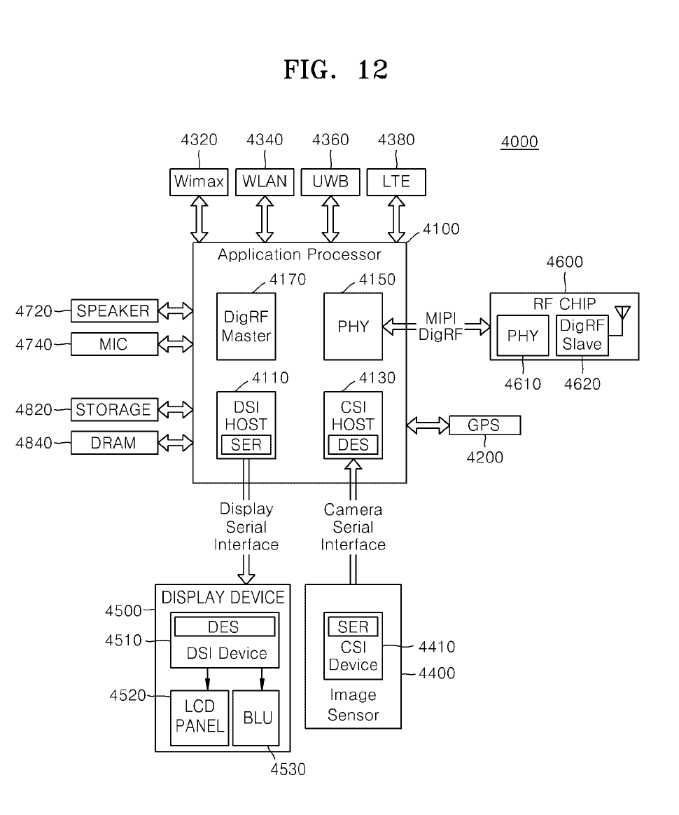

FIG. 12 is a block diagram of an electronic system including a display device, and interfaces of the electronic system according to an embodiment of the present disclosure.

Referring to FIG. 12, an electronic system 4000 is illustrated, where the electronic system 4000 may be implemented as a data processing device which is usable with or supports a MIPI interface, e.g., a mobile phone, a PDA, a PMP, or a smartphone. The electronic system 4000 may include an application processor 4100, an image sensor 4400, and a display device 4500.

A camera serial interface (CSI) host 4130 implemented in the application processor 4100 may communicate serially with a CSI device 4410 of the image sensor 4400 via a CSI. In this case, for example, the CSI host 4130 may include an optical deserializer (DES), and the CSI device 4410 may include an optical serializer (SER).

A display serial interface (DSI) host 4110 implemented in the application processor 4100 may communicate serially (e.g., by an optical SER) with a DSI device 4510, which may include an optical DES, of the display device 4500 via a DSI. The DSI may be any one of serial interfaces, such as MIPI®, MDDI, DisplayPort, I2C, and eDP interfaces. The display device 4500 may be a display apparatus 1000, as, for example, illustrated in FIG. 1, and the DSI device 4510 may be a semiconductor chip in which display driving circuits 200, 300, 400, and 600, as, for example, illustrated in FIG. 1 are integrated. The DSI host 4110 may provide image data and various kinds of control signals to the display device 4500 via the DSI. In this case, the DSI host 4110 may provide image data to be displayed on an LCD panel 4520, information on the brightness setting, and a signal for adjusting a brightness change delay time of a backlight unit (BLU) 4530 to the DSI device 4510. Accordingly, the display device 4500 may prevent a flickering phenomenon caused by visualizing a change in brightness when an image is changed.

The electronic system 4000 may further include a radio frequency (RF) chip 4600 communicable with the application processor 4100. A PHY 4150 of the application processor 4100 and a PHY 4610 of the RF chip 4600 may exchange data based on MIPI DigRF. The application processor 4100 may further include a DigRF Master 4170 that controls the data communications of the PHY 4150, and the RF chip 4600 may further include a DigRF Slave 4620 controlled by the DigRF Master 4170.

The electronic system 4000 may further include a global positioning system (GPS) 4200, a storage 4820, a DRAM 4840, a speaker 4720, and a microphone 4740 and may communicate with an external device by using one communication protocol (or communication standard), e.g., worldwide interoperability for microwave access (WiMAX) 4320, wireless local area network (WLAN) 4340, ultra-wideband (UWB) 4360, long term evolution (LTE™) 4380, or the like. The electronic system 4000 may communicate with an external device by using Bluetooth or Wi-Fi.

As described above, a display apparatus, a method of driving the display apparatus, and a portable terminal according to the one or more of the above embodiments of the present disclosure, by delaying a change in brightness of a backlight unit and adjusting a brightness change delay time of the backlight unit based on a brightness setting of the display apparatus when an image is changed, a flickering phenomenon of a screen caused by visualizing a change in brightness of a backlight may be prevented.

It should be understood that the various embodiments described therein should be considered in a descriptive sense only and not for purposes of limitation. Descriptions of features or aspects within each embodiment should typically be considered as available for other similar features or aspects in other embodiments.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A display apparatus comprising:
a display panel comprising a plurality of pixels, a plurality of gate lines connected to the plurality of pixels, and a plurality of data lines connected to the plurality of pixels;
a backlight unit configured to emit light on the display panel;
a data driver configured to apply a data signal to the plurality of data lines;
an image signal convertor configured to convert received image data to be suitable for a pixel arrangement of the display panel and to provide the converted image data to the data driver;
a backlight driver configured to adjust a brightness of the backlight unit based on the converted image data; and
a host controller configured to adjust a brightness change speed, when the brightness of the backlight unit is changed in correspondence with a change in the received image data.

2. The display apparatus of claim 1, wherein the host controller is further configured to set a brightness change delay time from a time point at which a change in brightness of the backlight unit is started to a time point at which the brightness of the backlight unit reaches a target brightness.

3. The display apparatus of claim 2, wherein the backlight driver is further configured to adjust a slew rate of a current output to be provided to the backlight unit, based on the brightness change delay time.

4. The display apparatus of claim 2, wherein the backlight driver is further configured to adjust a rate of change in a duty ratio of a pulse width modulation signal to be provided to the backlight unit, based on the brightness change delay time.

5. The display apparatus of claim 2, wherein the host controller is further configured to determine a brightness setting which is input through a user interface and to set the brightness change delay time depending on the brightness setting.

6. The display apparatus of claim 5, wherein the host controller is further configured to increase the brightness change delay time as the brightness setting is increased.

7. The display apparatus of claim 1, wherein the backlight driver is further configured to analyze a histogram of the converted image data and to set the brightness of the backlight unit based on a result of the analysis.

8. The display apparatus of claim 7, wherein the image signal convertor is further configured to scale the converted image data in correspondence with the set brightness of the backlight unit.

9. The display apparatus of claim 1, wherein the display panel further comprises red, green, blue, and white sub-pixels.

10. The display apparatus of claim 1, wherein the image signal convertor is further configured to receive RGB data including data of red, green, and blue colors as the received image data and to convert the received RGB data into RGBW data including data of red, green, blue, and white colors.

11. A portable terminal comprising:
a display panel including a plurality of unit pixels, each unit pixel of the plurality of unit pixels including red (R), green (G), blue (B), and white (W) sub-pixels;
a backlight unit configured to emit light on the display panel;
an application processor configured to determine a brightness setting based on a signal input through a user interface and to output a brightness setting signal;
a timing controller configured to convert received RGB image data including data of red, green and blue colors into RGBW image data including data of red, green, blue and white colors and to set a brightness change delay time of a backlight unit based on the brightness setting signal; and
a backlight driver configured to drive the backlight unit and to adjust a brightness of the backlight unit based on the brightness change delay time and the RGBW image data.

12. The portable terminal of claim 11, wherein the timing controller comprises:
an image convertor configured to convert the received RGB image data into the RGBW image data; and
a delay decision unit configured to set the brightness change delay time in response to the brightness setting signal.

13. The portable terminal of claim 12, wherein the delay decision unit is further configured to set the brightness change delay time based on the brightness setting signal and the brightness of the backlight unit.

14. The portable terminal of claim 11, wherein the backlight driver is further configured to adjust a slew rate of a current to be provided to the backlight unit, based on the brightness change delay time.

15. The portable terminal of claim 11, wherein the backlight driver is further configured to adjust a rate of change in a duty ratio of a pulse width modulation signal to be provided to the backlight unit, based on the brightness change delay time.

16. A method of driving a display apparatus, the method comprising:
setting, by a host controller of the display apparatus, a brightness change delay time according to a brightness setting set by a user;
converting image data to be suitable for a pixel arrangement of a display panel;
determining a brightness of a backlight unit based on a result of an analysis of the converted image data; and
changing the brightness of the backlight unit to the determined brightness of the backlight unit during the brightness change delay time.

17. The method of claim 16, wherein the changing of the brightness of the backlight unit comprises adjusting a slew rate of power to be provided to the backlight unit, based on the brightness change delay time.

18. The method of claim 16, wherein the changing of the brightness of the backlight unit comprises adjusting a rate of change in a duty ratio of a pulse width modulation signal to be provided to the backlight unit, based on the brightness change delay time.

19. The method of claim 16, wherein the display panel may include red, green, blue, and white sub-pixels.

20. The method of claim 16, wherein the brightness change delay time is increased as the brightness setting is increased.
